(19) United States
(12) Patent Application Publication
(10) Pub. No.: US 2025/0189426 A1
(43) Pub. Date: Jun. 12, 2025

(54) VEHICLE-BASED DUAL-COMB SPECTROMETER MEASUREMENTS

(71) Applicant: Honeywell International Inc., Charlotte, NC (US)

(72) Inventors: Thomas Dobbins, Watertown, MN (US); Chad Hoyt, Roseville, MN (US); Patrick Conry, Minnetonka, MN (US); Matthew Wiebold, Mankato, MN (US)

(73) Assignee: Honeywell International Inc., Charlotte, NC (US)

(21) Appl. No.: 18/740,290

(22) Filed: Jun. 11, 2024

Related U.S. Application Data
(60) Provisional application No. 63/609,777, filed on Dec. 13, 2023.
(60) Provisional application No. 63/607,912, filed on Dec. 8, 2023.

(51) Int. Cl. G01N 15/075; G06V 20/10; G06V 20/56

(52) U.S. Cl. CPC G01N 15/075; G06V 20/10; G06V 20/56

(57) ABSTRACT

Systems and methods for vehicle-based dual-come spectrometer measurements are described herein. In certain embodiments, a system includes a vehicle having a body with at least one aperture formed therein and a vehicle surface. Also, the system includes a dual-comb spectrometer mounted to the body, wherein the dual-comb spectrometer emits dual-comb optical signals through the at least one aperture towards a external surface, wherein the external surface is surface not part of the vehicle surface, wherein the dual-comb spectrometer receives reflected optical signals through the at least one aperture, wherein the reflected optical signals correspond to the dual-comb optical signals that have been reflected by the external surface. Further, the system includes one or more processors that produce measurements of an average concentration of at least one particle within a volume between the vehicle and the external surface based on spectrographic information from the reflected optical signals.

### CROSS-REFERENCE TO RELATED APPLICATIONS

The present application claims benefit of U.S. Patent Application Ser. Nos. 63/607,912 filed Dec. 8, 2023, and 63/609,777 filed on Dec. 13, 2023; the entire contents of each of the aforementioned patent applications are incorporated herein by reference as if set forth in its entirety.

### BACKGROUND

Changes in the Earth's climate profoundly impact the many interconnected systems operating on the Earth. Changes in ecosystems, precipitation patterns, and ocean levels can affect whether a species can survive on our shared planet. Understanding how the climate will change can help us prepare for, adapt to, or mitigate the effects of these changes. However, the climate is a complex and vast interconnected system that is difficult to model accurately. One challenge in modeling such a system is gathering sufficient data throughout the climate. With insufficient data, creating a useful climate model is challenging.

### SUMMARY

Systems and methods for vehicle-based dual-come spectrometer measurements are described herein. In certain embodiments, a system includes a vehicle having a body with at least one aperture formed therein and a vehicle surface. Also, the system includes a dual-comb spectrometer mounted to the body, wherein the dual-comb spectrometer is configured to emit dual-comb optical signals through the at least one aperture towards a external surface, wherein the external surface is surface not part of the vehicle surface, wherein the dual-comb spectrometer is configured to receive reflected optical signals through the at least one aperture, wherein the reflected optical signals correspond to the dual-comb optical signals that have been reflected by the external surface. Further, the system includes one or more processors configured to produce measurements of an average concentration of at least one particle within a volume between the vehicle and the external surface based on spectrographic information from the reflected optical signals.

### BRIEF DESCRIPTION OF DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a diagram illustrating multiple vehicles gathering environmental data using vehicle-based dual-comb spectrometers according to an aspect of the present disclosure;

FIG. 2 is a block diagram illustrating a system for acquiring environmental measurements from a vehicle-based dual-comb spectrometer according to an aspect of the present disclosure;

FIG. 3 is a diagram of a dual-comb spectrometer employed to gather environmental measurements according to an aspect of the present disclosure; and

FIG. 4 is a flowchart of a method for using vehicle-based dual-comb spectrometer measurements according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used, and that logical, mechanical, and electrical changes may be made.

Systems and methods for vehicle-based dual-comb spectrometer measurements are described herein. In certain embodiments, a dual-comb spectrometer (DCS) is mounted to a vehicle. As the vehicle passes through an environment, the vehicle may emit optical signals to interrogate an environmental volume between the vehicle and an external, non-vehicle surface. As the optical signals pass through the volume, the optical signals will be absorbed, scattered, and reflected by different molecules and particulates in the volume. The optical signals are then reflected off the external surface to be received by the DCS on the vehicle, passing through and interrogating the volume again. Based on the composition of the volume, the optical signal received by the DCS will contain spectrographic information indicating the average composition of the interrogated volume.

As stated above, gathering environmental information is important for performing atmospheric analysis and climate predictions. For example, a vehicle, like an airplane, may have a DCS mounted to the body of the airplane. As the airplane passes through an environment, the DCS may emit an optical signal to interrogate the volume of the atmosphere between the airplane and the ground beneath the airplane. When the optical signal returns after reflecting off the ground, the optical signal can be detected and analyzed to identify spectrographic information for the interrogated volume. From the spectrographic information, systems on the aircraft or another system in communication with the aircraft may identify the average composition of the interrogated volume. For example, the spectrographic information may indicate the average amount of greenhouse gases (water vapor, methane, N₂O, CO₂, CO, O₃, and the like), particulate matter, or other measurements of environmental data. A central system can then use the measurements of environmental data acquired from the spectrographic information with measurements acquired by other interrogations by similar systems to acquire a more comprehensive understanding of the composition of the atmosphere. The acquired understanding can improve the ability to predict and mitigate undesired climate changes.

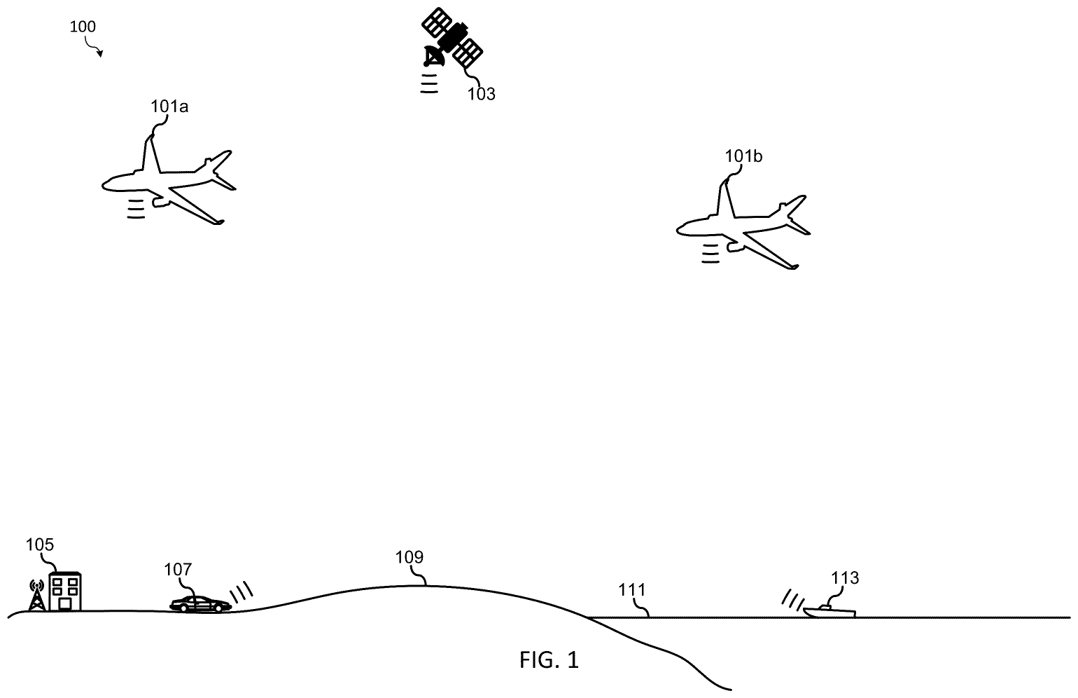

FIG. 1 is a diagram of an environment 100 through which multiple vehicles pass, gathering environmental data using vehicle-based dual-comb spectrometers. As illustrated, the environment 100 may contain multiple atmospheric volumes between a vehicle and an external surface. As described herein, an atmospheric volume is a volume comprising a portion of the atmosphere. Thus, an atmospheric volume includes gases and particulates suspended within the volume. As vehicles move, they pass through the environment 100. Examples of vehicles include aircraft 101 (airplanes, helicopters, missiles, drones, etc.), spacecraft 103 (rockets, satellites, etc.), land-based craft 107, watercraft 113, and the like.

In certain embodiments, the vehicles moving within the environment 100 have a DCS mounted thereon that emits an optical signal towards an external surface not part of the vehicle surface for measuring the average composition of the atmospheric volume between the vehicle and the surface. For example, a first aircraft 101a may emit an optical signal towards a external surface 109. The emitted optical signal then passes through the volume between the aircraft 101a and the external surface 109, where molecules and particles can reflect, absorb, and scatter the emitted optical signal. The emitted optical signal then reflects off the external surface 109 and passes through the volume again to be received by the DCS. The received optical signals can then be detected for processing, where subsequent processing can identify the composition of the volume between the aircraft 101a and the external surface 109 based on the spectrographic information of the received optical signals.

In further embodiments, when processing the detected optical signals reflected off the surface, the processing may consider information regarding the surface reflecting the emitted optical signals. For example, the external surface 109 is an example of a rocky terrain, and surface 111 is an example of water terrain. Accordingly, the vehicle may store information regarding the type of surface that reflects the emitted signal. For example, the aircraft 101b may store a terrain database that associates the current position of the vehicle with the surface immediately below the vehicle. Alternatively, the vehicle may include additional sensors, such as vision sensors, which allow computers on aircraft 101b to identify the type of surface reflecting the emitted optical signal.

In additional embodiments, when a vehicle receives the reflected optical signals, a detector may receive the detected signal and generate an electrical signal containing spectrographic information for subsequent processing. The spectrographic information contains measurements of the amplitudes of the different wavelengths of light received in the reflected optical signal. In some implementations, computers on the vehicle may perform the subsequent processing to generate measurements of the average composition of the volume from the spectrographic information. Alternatively, communication systems on the vehicle may transmit the spectrographic information to other systems that perform the subsequent processing. However, some data links may not support data rates or have associated costs that make transmitting the spectrographic information infeasible. Further, the spectrographic information may be stored on a memory device, where it can be downloaded by another system either directly or through another communication system, where the other system performs the subsequent processing.

In certain embodiments, the subsequent processing produces measurements of the average concentrations of certain molecules and particulates. For example, the measurements may identify the average concentrations of water vapor, methane, N₂O, CO₂, CO, O₃, and the like within the interrogated volume. In some implementations, the measurements may be provided to a control center 105 or some other center that uses the measurements for a desired purpose. For example, the control center 105 may accumulate measurements from multiple vehicles to gather information for the environment 100 to augment climate models and provide inputs to existing climate models. When providing information to the control center 105, a vehicle may transmit measurements immediately after calculation through a communication link. For example, the aircraft 101a may transmit information through a wireless communication link. The aircraft 101 may transmit the information directly to the control center 105 or through transmission relays. In at least one instance of relaying information to the control center 105, the aircraft 101b may transmit the information to a spacecraft 103 (such as a satellite), which transmits the information to the control center 105. Alternatively, the aircraft 101b may transmit the information to another aircraft, like aircraft 101a, which then relays the information to the control center 105.

In an alternative embodiment, the aircraft 101a may store the measurements until the aircraft 101a is proximate to the control center 105 or in a position where the measurements may be provided to the control center 105 using cheaper communication links, communication links controlled by an operator associated with the control center 105, or transferred to a portable computer readable medium that is physically delivered to the control center 105.

In additional embodiments, while the measurement of the composition of volumes has been described with respect to the aircraft 101a, other vehicles may also interrogate volumes within the environment. For example, vehicles may include spacecraft 103, land-based craft 107, watercraft 113, and the like. For instance, the land-based craft 107 and watercraft 113 may aim the emitted optical signals toward surfaces in the environment 100. For example, the land-based craft 107 may aim the emitted optical signals toward a mountain, a building, another vehicle, or other surface. Similarly, the watercraft 113 may also aim the emitted optical signals toward mountains, buildings, other vehicles, or other objects having surfaces. The spacecraft 103 may emit a signal from space towards a surface, similar to aircraft 101a and 101b.

Accordingly, as vehicles move through the environment 100, the different vehicles may interrogate volumes within the environment 100 using optical signals emitted and received by a DCS mounted on the respective vehicle. Measurements are produced and provided to a control center 105, where the control center 105 uses the measurements as inputs for climate prediction models or refining models.

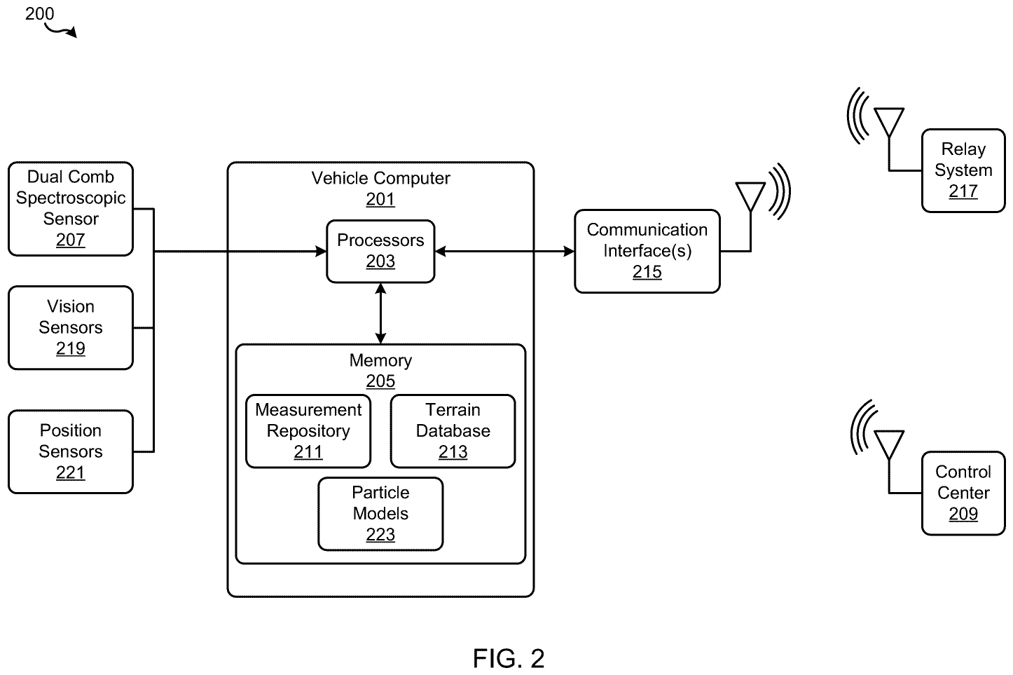

FIG. 2 is a block diagram of a system 200 for acquiring environmental measurements from a vehicle-based DCS. As illustrated, the system 200 includes a vehicle computer 201 and a DCS sensor 207. The vehicle computer 201 receives sensor data from the DCS sensor 207. The vehicle computer 201 may either calculate measurements of the average concentrations of different gases and particulates based on the sensor data, or the vehicle computer 201 may relay the received sensor data to a control center 209. The control center 209 may use the data as inputs for climate prediction models or refining models.

The vehicle computer 201 may include a processor(s) 203 and a memory 205. In certain embodiments, a processor 203 executes instructions that may direct the processor 203 to process the sensor data from the DCS sensor 207 to calculate the measurements of the average concentrations. Also, instructions may direct the processor 203 to transmit calculated measurements and/or sensor data to other systems or may save the measurements and/or sensor data in the memory 205. As described herein, the processor 203 may be a single processor or a device that includes combinations of general-purpose processors, multi-core processors, multiple processors, dedicated circuitry, and the like. The functions performed by the processor 203 may be implemented using software, firmware, hardware, or any appropriate combination thereof. The processors 203 and other computational devices may be supplemented by, or incorporated in, specially-designed application-specific integrated circuits (ASICs) or field programmable gate arrays (FPGAs). The processor 203 and other computational devices can also include or function with software programs, firmware, or other computer-readable instructions for performing various process tasks, calculations, and control functions used in the present methods and systems.

Further, methods described herein may be implemented by computer-executable instructions, such as program modules or components executed by the processor 203 or other computational devices. Generally, program modules include routines, programs, objects, data components, data structures, algorithms, and the like, which perform particular tasks or implement particular abstract data types.

In addition to the processor 203, the vehicle computer 201 also includes a memory 205. The memory 205 may be any suitable computer-readable storage media that includes, for example, non-volatile memory devices, including semiconductor memory devices such as random access memory (RAM), read-only memory (ROM), electrically erasable programmable ROM (EEPROM), or flash memory devices; magnetic disks such as internal hard disks or removable disks; optical storage devices such as compact discs (CDs), digital versatile discs (DVDs), Blu-ray discs, or other media that can carry or store desired program code as computer-executable instructions or data structures. Further, besides storing instructions for execution by the processor 203, the memory 205 may also store repositories for designated data groups. For example, the memory 205 includes memory dedicated for storing calculated measurements and databases of information that aid the processor 203 when processing the sensor data. In particular, the memory 205 may include a measurement repository 211, a terrain database 213, and/or particle models 223.

In some implementations, the system 200 may also include vision sensors 219 and/or position sensors 221. As used herein, vision sensors 219 include sensors that acquire information about the environment from captured images of the environment. The captured images may contain two-dimensional data or three-dimensional data. Using the two-dimensional data or three-dimensional data contained in the captured images, the processor 203 may identify the position and/or attitude of the vehicle using methods for identifying vehicle positions and attitudes from image data using methods known to one having skill in the art. Alternatively, the processor 203 may identify the type of surface reflecting the emitted optical signals. For example, the processor 203 may determine whether the reflecting surface is sand, tree cover, water, snow, rock, grasslands, or other type of surface type.

With respect to the position sensors 221, the position sensors 221 may provide position measurements or data that the processor 203 can use to identify the position and/or attitude of the vehicle. For example, the position sensors 221 may include global navigation satellite system (GNSS) receivers, inertial sensors, magnetometers, altimeters, barometers, and the like. In some implementations, the system 200 includes both position sensors 221 and the vision sensors 219, where the position sensors 221 are used to get the position of the vehicle and the vision sensors 219 are used to get the surface type that is reflecting the surface type.

In certain embodiments, the processor 203 may receive measurements from the DCS sensor 207 containing spectrographic measurements of an interrogated volume. The position sensors 221 and the vision sensors 219 may provide information about the position of the vehicle, and the vision sensors 219 may provide information that can be used to identify the reflecting surface type. In some implementations, the processor 203 may use information about the type of the reflecting surface to characterize the interaction of the reflecting surface with the emitted light. By characterizing the interaction of the surface with the emitted light, the processor 203 may isolate the information in the spectrographic information that is associated with the reflection of the emitted light by the reflecting surface from the information in the spectrographic information that is associated with the composition of the interrogated volume.

When the processor 203 has isolated the portion of the spectrographic information associated with the composition of the interrogated volume, the processor 203 may identify the composition of different gases by analyzing the isolated data in the spectrographic information received from the DCS sensor 207. For example, for a particular molecule or particle, the processor 203 may compare the spectrographic information against particle models stored in the particle models 223. The particle models 223 may store multiple models of different compositions of a particular particle or molecule. The processor 203 then compares the spectrographic information against the multiple models to identify the model closest to the spectrographic information. For example, the processor 203 may correlate the received information with the different stored models, and the model with the highest correlation may be used to identify the average composition of the interrogated volume for the modeled particle. The particle models 223 may store models for multiple particles and molecules, and the processor 203 may identify the average compositions of multiple particles and molecules for the interrogated volume. In alternative embodiments, the processor 203 may calculate the average compositions directly from the spectrographic information without using data stored in the particle models 223.

In alternative embodiments, the processor 203 may acquire information about the type of the reflecting surface from a terrain database 213. For example, the terrain database 213 may store information about the terrain types associated with particular geographic locations. As such, the processor 203 may identify a position based on information from the position sensors 221 and then identify the terrain type associated with the position stored in the terrain database 213. In some implementations, the processor 203 uses the information in the terrain database 213 in combination with the information received from the vision sensors 219 to characterize the terrain type.

When the processor 203 has calculated the measurements of the average composition of the interrogated volume, the processor 203 may provide the information to a control center 209 for further analysis. In some implementations, the processor 203 provides the measurements to the control center 209 through a communication interface 215. As used herein, the communication interface 215 is a communication link interface that allows the vehicle computer 201 to communicate through a communication link. For example, the communication interface 215 may interface with a SATCOM, VHF, 5G, IP, or other type of communication link. Additionally, the communication interface 215 may transmit the measurements to the control center 209 through a relay system 217. The relay system 217 then relays the received measurements to another relay system or directly to the control center 209. For example, an aircraft may relay the measurements through another aircraft using an ADS-B communication link to the control center 209. In some embodiments, where the communication link supports sufficient data rates, the vehicle computer 201 may transmit the spectrographic information to the control center 209, where the control center 209 then calculates the composition measurements for the interrogated volumes.

In additional embodiments, the processor 203 may store the spectrographic information, the calculated measurements, and/or the position associated with the acquired spectrographic information in the measurement repository 211. For example, potentially, where communication interfaces 215 cannot communicate with or relay measurements to the control center 209, the processor 203 may store data in the measurement repository 211. When the vehicle can establish a communication link with the control center 209 (for example, when landing or moving into a coverage area associated with a communication link), the processor 203 may transmit the stored measurements and data to the control center 209 either through the communication interfaces 215, through a direct connection to the control center 209, or through physically moving the measurement repository from the vehicle to the control center 209. With the data from the vehicle computer 201 and other similar vehicle computers, the control center 209 may provide higher-quality inputs to climate models. Also, the data may be used to improve the climate models.

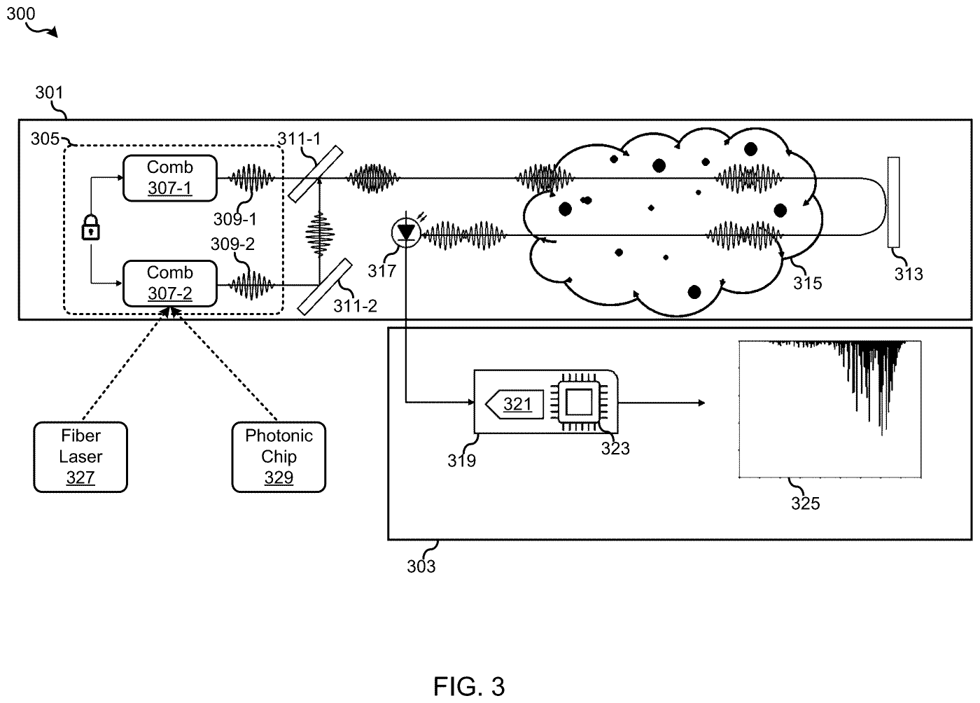

FIG. 3 is a diagram illustrating a dual-comb spectrometer sensor system 300 used in the systems described above. As illustrated, the system 300 includes two portions: an optical domain component 301 and an RF/Digital domain 303. As illustrated, the optical domain component 301 includes an optical signal source 305 that generates two optical frequency combs. Examples of potential optical signal sources include a fiber laser 327, a photonics chip 329, or other potential laser sources. To generate the two optical frequency combs, the optical signal source 305 may include a first comb source 307-1 that generates a first optical frequency comb 309-1 and a second comb source 307-2 that generates a second optical frequency comb 309-2. Optionally, the first optical frequency comb 309-1 and the second optical frequency comb 309-2 are phase-locked with each other. Each optical frequency comb includes spectral components in an optical spectrum. Each pair of adjacent spectral components, of each optical frequency comb, are separated by a constant frequency.

However, such constant frequency separation differs between the first optical frequency comb 309-1 and the second optical frequency comb 309-2. The constant frequency separation for the first optical frequency comb 309-1 is a first separation frequency fₛ. The constant frequency separation for the second optical frequency comb 309-2 is a second separation frequency fₛ+Δf. Δf may be referred to as an offset frequency. Optionally, the first separation frequency fₛ is at least four orders of magnitude greater than the offset frequency Δf.

As illustrated, the first optical frequency comb 309-1 and the second optical frequency comb 309-2 are combined using optical components 311-1 and 311-2. The optical components 311-1 and 311-2 may include optical components that combine the first optical frequency comb 309-1 and the second optical frequency comb 309-2 and direct them towards the reflecting surface through the interrogated volume. For example, the optical components 311-1 and 311-2 may include mirrors, partially reflective mirrors, polarizers, wave plates, collimators, and the like. When the first optical frequency comb 309-1 and the second optical frequency comb 309-2 are combined, they are emitted from an aperture in the vehicle. When the first optical frequency comb 309-1 and the second optical frequency comb 309-2 are emitted from the aperture, they pass through a volume 315 between the vehicle and the reflecting surface and are incident on the surface 313. The reflecting surface 313 reflects the first optical frequency comb 309-1 and the second optical frequency comb 309-2 back towards the vehicle, where they pass through the aperture to be incident on a photodetector 317.

In certain embodiments, the photodetector 317 receives the reflected first optical frequency comb 309-1 and the second optical frequency comb 309-2 after each has propagated twice through the interrogated volume 315. The photodetector 317 generates an electrical signal representing a heterodyne beat frequency comb, e.g., in a radio spectrum below the optical spectrum. The photodetector 317 then provides the electrical signal to the RF/Digital domain 303.

Within the RF/digital domain 303, the electrical signal is received by processing circuitry 319 that generates spectrographic information 325. The processing circuitry 319 may include an FPGA, a CPU, or other computational device. Additionally, the processing circuitry 319 may include additional circuitry that facilitates processing the signal received from the photodetector 317. For example, as the signal produced by the photodetector 317 may be an analog electrical signal, the processing circuitry 319 may include an analog-to-digital converter (ADC) 321 that converts the detected signal into the digital domain. Moreover, the processing circuitry 319 may include a processor 323 that generates spectrographic information 325 from the digital signal. The processor 323 may function similarly to the processor 203 in FIG. 2. Alternatively, the processing may be performed by the processor 203 in FIG. 2. When the spectrographic information 325 has been generated, a processor (such as processor 203) may perform additional processing to acquire the measurements of the particles and molecules contained within the interrogated volume 315, as described above.

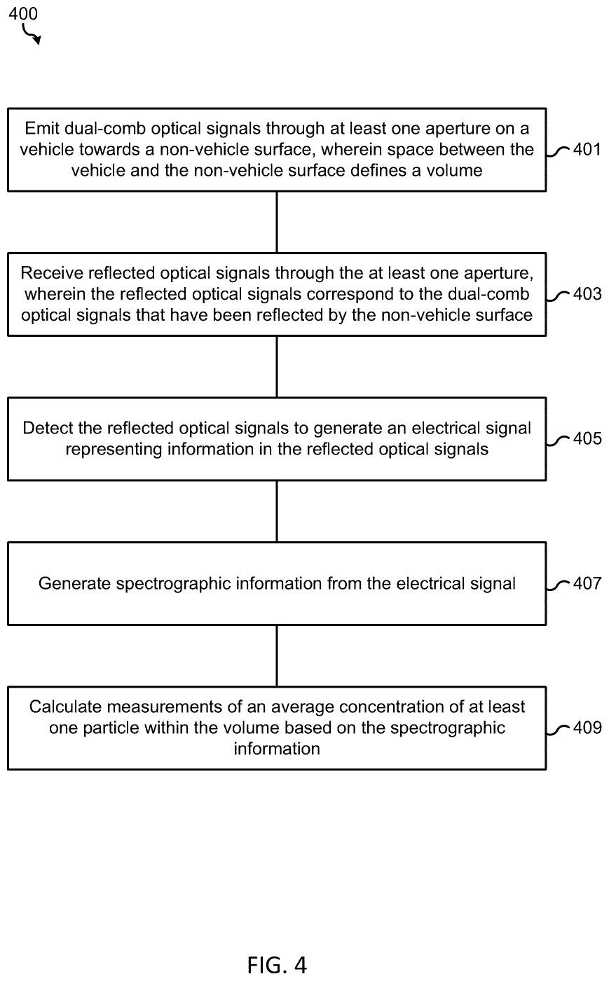

FIG. 4 is a flowchart diagram of a method 400 for providing vehicle-based dual-comb spectrometer measurements. In certain embodiments, the method 400 proceeds at 401 where dual-comb optical signals are emitted through at least one aperture on a vehicle towards an external surface, wherein space between the vehicle and the external surface defines a volume. Also, the method 400 proceeds at 403, where reflected optical signals are received through the at least one aperture, wherein the reflected optical signals correspond to the dual-comb optical signals that have been reflected by the external surface. Additionally, the method 400 proceeds at 405, where the reflected optical signals are detected to generate an electrical signal representing information in the reflected optical signals.

In additional embodiments, the method 400 proceeds at 407, where spectrographic information is generated from the electrical signal. In some implementations, because the emitted signals are reflected by an external surface and the terrain of the external surface affects the spectrographic information in addition to the effects of particles in the volume of air between the vehicle and the external surface, the generation of spectrographic information may include characterizing the terrain type of the external surface and removing spectrographic information from the electrical signal associated with the characterized terrain type.

In some implementations, the terrain type may be characterized using position sensors that help identify the position and attitude of the vehicle in conjunction with a terrain database that associates terrain types with different locations on the external surface (like the surface of the earth). Accordingly, after identifying the position and attitude of the vehicle, processors (on the vehicle or control center) may use the position and attitude to identify the location on the external surface that is reflecting the emitted signal back to the vehicle. The processors may then identify the terrain type associated with the identified location on the external surface in a terrain database. When the terrain type is identified, the processors may remove spectrographic information from the electrical signals associated with the terrain type in relation to the position and attitude of the vehicle.

In alternative implementations, the terrain type may be characterized using image sensors located on the vehicle. In particular, the image sensors on the vehicle may emit one or more optical signals toward the external surface. The received optical signals may be detected, and the resultant electrical signals may be processed to identify the terrain type from the collected image data. For example, the image data may be matched to an image database, like satellite image databases, or the image data may be analyzed directly to identify the terrain type. When the terrain type is identified, the processors may remove spectrographic information from the electrical signals associated with the terrain type represented in the image data.

In certain embodiments, the method 400 proceeds at 409, where measurements of an average concentration of at least one particle within the volume are calculated based on the spectrographic information. Additionally, when calculating the measurements, spectrographic information may be provided to a control center where at least one processor located at the control center calculates the measurements of the average concentration or at least one processor located on the vehicle performs the calculations. When information is provided to the control center, where the information is the spectrographic information or measurements calculated by on-vehicle processors, the information may be transmitted from the vehicle to the control center through one or more communication interfaces. In some implementations, when the vehicle is not in direct communication with the control center, the information may be relayed to the control center through transmissions from the vehicle to a relay system. The relay system may include other vehicles, relay stations, and the like. Alternatively, the information may be stored on a physical storage medium on the vehicle, where the physical storage medium may be provided to the control center when convenient.

In additional embodiments, calculating the measurements of the average concentration of at least one particle, at either the vehicle or control center, includes acquiring multiple particle models, where a particle model represents expected spectrographic information for particular concentrations of a particle. The processors may then compare the spectrographic information against the stored particle models to identify which of the particle models for a particle are most closely correlated with the spectrographic information. When the processor identifies the particle models with the highest correlation, the processor may determine that the average concentration of the most highly correlated particle model is the approximate average concentration of that particle within the interrogated environmental volume.

### Example Embodiments

Example 1 includes a system comprising: a vehicle having a body with at least one aperture formed therein and a vehicle surface; a dual-comb spectrometer mounted to the body, wherein the dual-comb spectrometer is configured to emit dual-comb optical signals through the at least one aperture towards a external surface, wherein the external surface is surface not part of the vehicle surface, wherein the dual-comb spectrometer is configured to receive reflected optical signals through the at least one aperture, wherein the reflected optical signals correspond to the dual-comb optical signals that have been reflected by the external surface; and one or more processors configured to produce measurements of an average concentration of at least one particle within a volume between the vehicle and the external surface based on spectrographic information from the reflected optical signals.

Example 2 includes the system of Example 1, wherein the at least one particle is at least one of: water vapor; methane; nitrous oxide; carbon dioxide; carbon monoxide; and ozone.

Example 3 includes the system of any of Examples 1-2, wherein at least one processor in the one or more processors is located on the vehicle and the at least one processor produces the measurements.

Example 4 includes the system of any of Examples 1-3, further comprising one or more communication interfaces, wherein data transmitted through the one or more communication interfaces comprises at least one of the spectrographic information, and the measurements of the average concentration are transmitted through the one or more communication interfaces to a control center.

Example 5 includes the system of Example 4, wherein the data transmitted through the one or more communication interfaces is transmitted to a relay system, which relays the data to the control center.

Example 6 includes the system of any of Examples 4-5, wherein the spectrographic information is transmitted to the control center and the one or more processors is located at the control center and produces the measurements from the spectrographic information transmitted through the one or more communication interfaces.

Example 7 includes the system of any of Examples 1-6, further comprising: one or more position sensors configured to determine position and attitude of the vehicle; and a memory configured to store a terrain database; wherein at least one processor in the one or more processors is configured to identify a terrain associated with the external surface based on terrain information stored in the terrain database that is associated with the position and the attitude of the vehicle; wherein the at least one processor adjust the spectrographic information based on the terrain.

Example 8 includes the system of any of Examples 1-7, further comprising: a memory configured to store one or more particle models; wherein at least one processor in the one or more processors is configured to identify the average concentration of the at least one particle by correlating the spectrographic information with the one or more particle models.

Example 9 includes the system of any of Examples 1-8, wherein the one or more processors are configured to directly calculate the average concentration of the at least one particle from the spectrographic information.

Example 10 includes the system of any of Examples 1-9, further comprising: one or more vision sensors configured to provide image information of the external surface; wherein at least one processor in the one or more processors is configured to identify a surface type for the external surface; and wherein the at least one processor adjusts the spectrographic information based on the surface type.

Example 11 includes a method, comprising: emitting dual-comb optical signals through at least one aperture on a vehicle towards an external surface, wherein space between the vehicle and the external surface defines a volume, wherein the external surface is a surface not part of a surface of the vehicle; receiving reflected optical signals through the at least one aperture, wherein the reflected optical signals correspond to the dual-comb optical signals that have been reflected by the external surface; detecting the reflected optical signals to generate an electrical signal representing information in the reflected optical signals; generating spectrographic information from the electrical signal; and calculating measurements of an average concentration of at least one particle within the volume based on the spectrographic information.

Example 12 includes the method of Example 11, wherein calculating the measurements of the average concentration further comprises providing the spectrographic information to a control center, wherein the measurements of the average concentration are performed by at least one processor located at the control center.

Example 13 includes the method of any of Examples 11-12, further comprising: providing at least one of the spectrographic information and the measurements of the average concentration to a control center through at least one of: transmitting at least one of the spectrographic information and the measurements of the average concentration to the control center through one or more communication interfaces; and storing at least one of the spectrographic information and the measurements of the average concentration on a vehicle memory and providing at least one of the spectrographic information and the measurements to the control center when the vehicle is proximate to the control center.

Example 14 includes the method of Example 13, wherein transmitting at least one of the spectrographic information, and the measurements of the average concentration to the control center further comprises transmitting the at least one of the spectrographic information and the measurements through a relay system towards the control center.

Example 15 includes the method of any of Examples 11-14, wherein generating the spectrographic information further comprises: identifying position and attitude of the vehicle using one or more position sensors located on the vehicle; identifying a terrain type in a terrain database associated with the position and the attitude of the vehicle in relation to the external surface; and removing terrain spectrographic information associated with the terrain type from the spectrographic information.

Example 16 includes the method of any of Examples 11-15, wherein generating the spectrographic information further comprises: acquiring image information of the external surface through one or more vision sensors located on the vehicle; identifying a terrain type based on the image information; and removing terrain spectrographic information associated with the terrain type from the spectrographic information.

Example 17 includes the method of any of Examples 11-16, wherein calculating the measurements of the average concentration of the at least one particle comprises: acquiring a plurality of particle models, wherein a particle model represents expected spectrographic information for particular concentrations of a particle; correlating the spectrographic information with the plurality of particle models; and calculating the measurements of the average concentration based on correlations of the spectrographic information with the plurality of particle models.

Example 18 includes the method of any of Examples 11-17, wherein the at least one particle is at least one of: water vapor; methane; nitrous oxide; carbon dioxide; carbon monoxide; and ozone.

Example 19 includes a system comprising: a vehicle having a body with at least one aperture formed therein and a vehicle surface; one or more sensors configured to acquire at least one of vision information and position and attitude information of the vehicle; one or more communication interfaces for communicating with one or more other systems; a dual-comb spectrometer mounted to a vehicle body, wherein the dual-comb spectrometer is configured to emit dual-comb optical signals through the at least one aperture towards an external surface, wherein the external surface is a surface not part e surface, wherein the dual-comb spectrometer is configured to receive reflected optical signals through the at least one aperture, wherein the reflected optical signals correspond to the dual-comb optical signals that have been reflected by the external surface; one or more processors configured to produce measurements of an average concentration of at least one particle within a volume between the vehicle and the external surface based on spectrographic information from the reflected optical signals; and a memory configured to store at least one of a repository of the measurements of the average concentration, a terrain database, and a plurality of particle models.

Example 20 includes the system of Example 19, wherein the one or more processors uses at least one of the vision information and the position and attitude information to identify terrain spectrographic information associated with a terrain of the external surface and removes the terrain spectrographic information from the spectrographic information from the reflected optical signals before the one or more processors produce the measurements of the average concentration of the at least one particle.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a vehicle having a body with at least one aperture formed therein and a vehicle surface;
a dual-comb spectrometer mounted to the body, wherein the dual-comb spectrometer is configured to emit dual-comb optical signals through the at least one aperture towards a external surface, wherein the external surface is surface not part of the vehicle surface, wherein the dual-comb spectrometer is configured to receive reflected optical signals through the at least one aperture, wherein the reflected optical signals correspond to the dual-comb optical signals that have been reflected by the external surface; and
one or more processors configured to produce measurements of an average concentration of at least one particle within a volume between the vehicle and the external surface based on spectrographic information from the reflected optical signals.

2. The system of claim 1, wherein the at least one particle is at least one of:
water vapor;
methane;
nitrous oxide;
carbon dioxide;
carbon monoxide; and
ozone.

3. The system of claim 1, wherein at least one processor in the one or more processors is located on the vehicle and the at least one processor produces the measurements.

4. The system of claim 1, further comprising one or more communication interfaces, wherein data transmitted through the one or more communication interfaces comprises at least one of the spectrographic information and the measurements of the average concentration are transmitted through the one or more communication interfaces to a control center.

5. The system of claim 4, wherein the data transmitted through the one or more communication interfaces is transmitted to a relay system, which relays the data to the control center.

6. The system of claim 4, wherein the spectrographic information is transmitted to the control center and the one or more processors is located at the control center and produces the measurements from the spectrographic information transmitted through the one or more communication interfaces.

7. The system of claim 1, further comprising:
one or more position sensors configured to determine position and attitude of the vehicle; and
a memory configured to store a terrain database;
wherein at least one processor in the one or more processors is configured to identify a terrain associated with the external surface based on terrain information stored in the terrain database that is associated with the position and the attitude of the vehicle;
wherein the at least one processor adjust the spectrographic information based on the terrain.

8. The system of claim 1, further comprising:
a memory configured to store one or more particle models;
wherein at least one processor in the one or more processors is configured to identify the average concentration of the at least one particle by correlating the spectrographic information with the one or more particle models.

9. The system of claim 1, wherein the one or more processors are configured to directly calculate the average concentration of the at least one particle from the spectrographic information.

10. The system of claim 1, further comprising:
one or more vision sensors configured to provide image information of the external surface;
wherein at least one processor in the one or more processors is configured to identify a surface type for the external surface; and
wherein the at least one processor adjusts the spectrographic information based on the surface type.

11. A method, comprising:
emitting dual-comb optical signals through at least one aperture on a vehicle towards an external surface, wherein space between the vehicle and the external surface defines a volume, wherein the external surface is a surface not part of a surface of the vehicle;
receiving reflected optical signals through the at least one aperture, wherein the reflected optical signals correspond to the dual-comb optical signals that have been reflected by the external surface;
detecting the reflected optical signals to generate an electrical signal representing information in the reflected optical signals;
generating spectrographic information from the electrical signal; and
calculating measurements of an average concentration of at least one particle within the volume based on the spectrographic information.

12. The method of claim 11, wherein calculating the measurements of the average concentration further comprises providing the spectrographic information to a control center, wherein the measurements of the average concentration are performed by at least one processor located at the control center.

13. The method of claim 11, further comprising:
providing at least one of the spectrographic information and the measurements of the average concentration to a control center through at least one of:
transmitting at least one of the spectrographic information and the measurements of the average concentration to the control center through one or more communication interfaces; and
storing at least one of the spectrographic information and the measurements of the average concentration on a vehicle memory and providing at least one of the spectrographic information and the measurements to the control center when the vehicle is proximate to the control center.

14. The method of claim 13, wherein transmitting at least one of the spectrographic information and the measurements of the average concentration to the control center further comprises transmitting the at least one of the spectrographic information and the measurements through a relay system towards the control center.

15. The method of claim 11, wherein generating the spectrographic information further comprises:
identifying position and attitude of the vehicle using one or more position sensors located on the vehicle;
identifying a terrain type in a terrain database associated with the position and the attitude of the vehicle in relation to the external surface; and
removing terrain spectrographic information associated with the terrain type from the spectrographic information.

16. The method of claim 11, wherein generating the spectrographic information further comprises:
acquiring image information of the external surface through one or more vision sensors located on the vehicle;
identifying a terrain type based on the image information; and
removing terrain spectrographic information associated with the terrain type from the spectrographic information.

17. The method of claim 11, wherein calculating the measurements of the average concentration of the at least one particle comprises:
acquiring a plurality of particle models, wherein a particle model represents expected spectrographic information for particular concentrations of a particle;
correlating the spectrographic information with the plurality of particle models; and
calculating the measurements of the average concentration based on correlations of the spectrographic information with the plurality of particle models.

18. The method of claim 11, wherein the at least one particle is at least one of:
water vapor;
methane;
nitrous oxide;
carbon dioxide;
carbon monoxide; and
ozone.

19. A system comprising:
a vehicle having a body with at least one aperture formed therein and a vehicle surface;
one or more sensors configured to acquire at least one of vision information and position and attitude information of the vehicle;
one or more communication interfaces for communicating with one or more other systems;
a dual-comb spectrometer mounted to a vehicle body, wherein the dual-comb spectrometer is configured to emit dual-comb optical signals through the at least one aperture towards an external surface, wherein the external surface is a surface not part e surface, wherein the dual-comb spectrometer is configured to receive reflected optical signals through the at least one aperture, wherein the reflected optical signals correspond to the dual-comb optical signals that have been reflected by the external surface;
one or more processors configured to produce measurements of an average concentration of at least one particle within a volume between the vehicle and the external surface based on spectrographic information from the reflected optical signals; and
a memory configured to store at least one of a repository of the measurements of the average concentration, a terrain database, and a plurality of particle models.

20. The system of claim 19, wherein the one or more processors uses at least one of the vision information and the position and attitude information to identify terrain spectrographic information associated with a terrain of the external surface and removes the terrain spectrographic information from the spectrographic information from the reflected optical signals before the one or more processors produce the measurements of the average concentration of the at least one particle.
